(19) United States
(12) Patent Application Publication
(10) Pub. No.: US 2013/0311696 A1
(43) Pub. Date: Nov. 21, 2013

(54) STORAGE PROCESSOR FOR EFFICIENT SCALING OF SOLID STATE STORAGE

(71) Applicants: Gregory L. Huff, The Woodlands, TX (US); Robert E. Ober, Santa Clara, CA (US); Steven M. Emerson, Chanhassen, MN (US)

(72) Inventors: Gregory L. Huff, The Woodlands, TX (US); Robert E. Ober, Santa Clara, CA (US); Steven M. Emerson, Chanhassen, MN (US)

(73) Assignee: LSI Corporation, Milpitas, CA (US)

(21) Appl. No.: 13/474,770

(22) Filed: May 18, 2012

(51) Int. Cl. G06F 13/42

(52) U.S. Cl. 710/316

(57) ABSTRACT

An SSD controller with two SAS interfaces includes an internal switch or expander to allow the SSD controller to function as both an initiator and target. Data packets received through one of the SAS interfaces may be directed to solid state memory elements directly connected to the SSD controller, or to one or more devices connected to the other SAS interface.

### FIELD OF THE INVENTION

The present invention is directed generally toward solid state drive controllers and more particularly toward solid state storage device controllers adapted for expandability.

### BACKGROUND OF THE INVENTION

Storage systems today are in transition to integrate large amounts of NAND flash memory to enable much higher storage system performance (IOPs, Bandwidth and/or lower-latency) than was previously done with traditional storage systems built on hard disk drives (HDDs). One key design factor in efficiently integrating flash in a storage system is to be able to allocate a significant amount of the system power budget to the flash memory subsystem. It is well-known that the performance that can be obtained in a storage system with flash is directly related to the number of active flash die which in turn is related to the amount of power consumed by the flash memory subsystem. More active die means higher system performance but greater power consumed. The basic makeup of today's flash solutions consist of three parts: the flash memory subsystem; the flash storage processor (or flash controller) and usually some DRAM based buffer memory; each of these components is scaled (in power and size) to meet the needs of different flash solutions, but in all cases, it is important to keep the power allocated to the flash storage processor and DRAM buffer as low as possible, reserving as much as possible for the flash memory itself.

Another problem is that it is important to be able to easily scale the solution from storage systems with small amounts of flash to systems with large amounts of flash and to do this without having to re-design the flash storage processor for each new design point. In order to design a scalable flash-based storage system without redesigning the Flash Storage Processor for each design point, one can either add external switches to aggregate multiple Flash Storage Processors or design the Flash Storage Processor itself to be scalable. To scale the solution one must scale both the interconnect between the host and the flash storage processor, and the number of flash channels to the flash storage array.

One method is to implement a single, monolithic device which has all the necessary interconnect to the host and channels to the flash array to support all possible solutions across various performance and capacity design points. The problem with this approach is that it is optimized for the highest performance and largest system, but suboptimal for all other configurations. It is also very difficult to economically create a board layout that can accommodate the very large number of signals attached to that device, which can quickly become more than 1000 signals. Flash-Based storage systems that need less flash would carry the burden (power, cost, area) of interconnect needed to support systems with larger flash-based storage systems.

Another method is to implement a two-tier approach where the top tier is an aggregator type device or switch which includes a host facing interface and multiple target facing ports which interconnect to a 2nd-tier of flash storage processors which in turn connect directly to flash memories. The number of target facing ports is directly related to the number of flash storage processors you may want to support across different performance and capacity points. In this architecture, the number of target facing ports must be known in advance. If the intent is to mix solid state storage devices such as NAND flash, MRAM, PCM, ReRAM, NVRAM or other solid state drives (SSDs), and Hard Disk Drive (HDDs) to build large scale hybrid storage solutions, then enough target facing ports are required for all flash storage processors and all hard disks in the system. One skilled in the art may appreciate that “solid state storage device” and “SSD” may refer to any solid state memory technology.

Consequently, it would be advantageous if an apparatus existed that embeds a scalable element into the design of the Flash Storage Processor such that additional performance and capacity can be easily gained by simply adding additional Scalable Flash Storage Processors. In this way additional interconnect and flash channels are only added when needed. The scalable element can be any of a switch, expander or multiplexor/demultiplexor.

### SUMMARY OF THE INVENTION

Accordingly, the present invention is directed to a novel method and apparatus for expanding available SSD memory in a computer system by embedding a small switch or expander into a Flash Storage Processor device and interconnecting them in such a way as to achieve a more economical way of scaling flash-based storage.

A SAS-based Flash storage target (hereafter termed “Scalable SAS Target”) with two SAS interfaces whereby one SAS port is used to attach to a device which aggregates SAS traffic from many HDD or SSD storage targets up to a host and another SAS interface which is used to connect additional SAS SSD or HDD targets in essence, scaling additional SAS ports for connection with each new “Scalable SAS Target” connected. Each SAS interface or SAS port may comprise a one or more signal lanes. Ports comprising two or more signal lanes are commonly referred to as “wideport” interfaces. Wideports can be split into connections to aggregate single port target devices such as HDDs. The advantage with this configuration is that the SAS Flash Storage Processor does not need to be designed with sufficient interconnect to scale across all possible design points; the ports scale as one adds additional “Scalable SAS Targets”. The other essential advantage is that the power associated with the interconnect scales in the same manner. It should be noted that although this scheme scales ports and interconnect power, the scheme does not scale bandwidth. Bandwidth to the host is shared when aggregating additional downstream traffic thru the connection of additional SAS SSD or HDD targets.

The “Scalable SAS Target” achieves this attribute by embedding a small 4-port SAS switch, with 2 of the SAS ports connecting externally as described earlier. This embodiment has no modes in operation. SAS commands destined for the SSD are executed directly, and SAS commands targeted to any subsequent downstream devices are routed externally to the downstream port.

It should be noted that the two SAS ports can be used in a Dual Port SAS mode where both SAS ports connect to a host device and no ports are used to interconnect downstream devices. In this case, the dual SAS ports are used to provide redundancy as is typical for current dual-port SAS target devices. Adding the downstream port does not cost any additional device pins as compared to current Dual Port SAS Flash Storage Processors.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of one embodiment of an SSD controller according to the present invention;

FIG. 2 shows a block diagram of another embodiment of an SSD controller according to the present invention;

FIG. 3 shows a block diagram of a system utilizing the present invention;

FIG. 4 shows a block diagram of a system utilizing the present invention;

FIG. 5 shows a block diagram of a system utilizing two controllers with three SSD controllers according to the present invention;

FIG. 6 shows a block diagram of a system utilizing a controller and SSD controllers according to the present invention to create a scalable topology;

FIG. 7 shows a block diagram of a system utilizing a controller, an expander and SSD controllers according to the present invention to create a scalable topology;

FIG. 8 shows a block diagram of a system including a controller, three SSD controllers, three expanders and three HDDs; and

FIG. 9 shows a block diagram of a system utilizing a controller and three SSD controllers in a daisy chain configuration.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

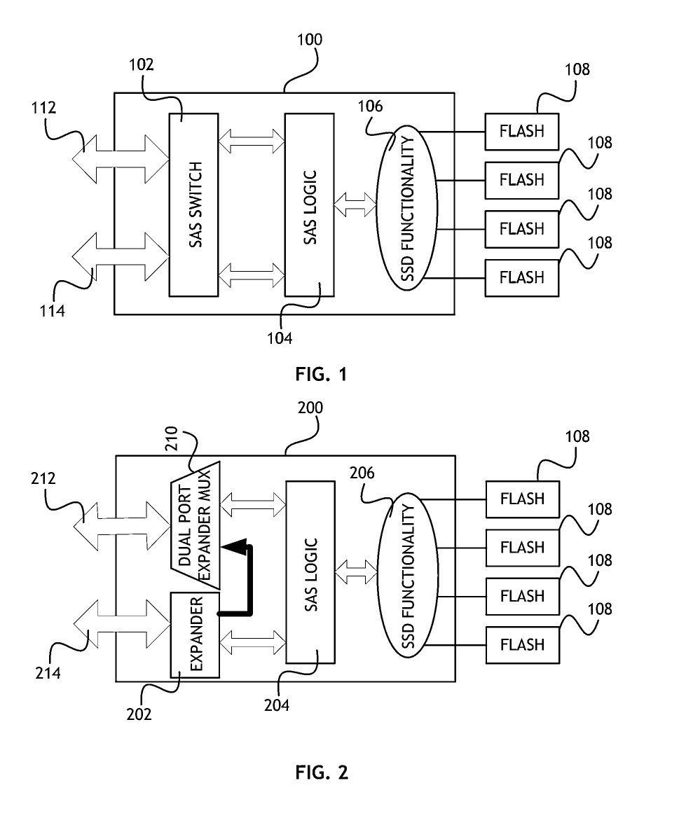

Referring to FIG. 1, an SSD controller 100 according to the present invention is shown. The SSD controller 100 may include an SAS logic circuit 104 having two ports. The SAS logic circuit 104 may be connected to an SSD functionality circuit 106 that provides access to one or more solid state memory elements 108 (solid state storage devices). Solid state memory elements 108 may comprise NAND flash, Phase-Change Memory (PCM), Resistive Random Access Memory (ReRAM), Magnetoresistive Random Access Memory (MRAM) or other Non-volatile Random Access Memory (NVRAM). The SSD controller 100 may also include an SAS switch 102 having four ports. The SAS switch 102 may route data traffic through a first SAS interface and a second SAS interface in the SSD controller 100. The SAS switch 102 may be connected to the SAS logic circuit 104 through two ports. The SAS logic circuit 104 may send and receive data traffic through the SAS switch 102 as if the SAS logic circuit 104 were configured as an SAS target device. The SAS switch 102 may send and receive data traffic through the first SAS interface and the second SAS interface as either a target device or initiator device.

While the SSD controller 100 is shown implemented through various SAS components, a person skilled in the art may appreciate that other technologies may also be used. For example, the SSD controller 100 may be implemented with devices using Serial Advanced Technology Attachment (SATA) or Peripheral Component Interconnect Express (PCIe).

Referring to FIG. 2, an SSD controller 200 according to the present invention is shown. The SSD controller 100 may include an SAS logic circuit 204 having two ports. The SAS logic circuit 204 may be connected to an SSD functionality circuit 206 that provides access to one or more elements of solid state memory elements 108. The SSD controller 200 may also include an expander 202 connected to the SAS logic circuit 204 and further connected to a dual port expander multiplexer 210. The dual port expander multiplexer 210 may also be connected to the SAS logic circuit 204 The expander 202 and dual port expander multiplexer 210 may route data traffic through a first SAS interface and a second SAS interface in the SSD controller 200. The SAS logic circuit 204 may send and receive data traffic through the expander 202 and dual port expander multiplexer 210 as if the SAS logic circuit 104 were configured as an SAS target device. The expander 202 and dual port expander multiplexer 210 may send and receive data traffic through the first SAS interface and the second SAS interface as either a target device or initiator device.

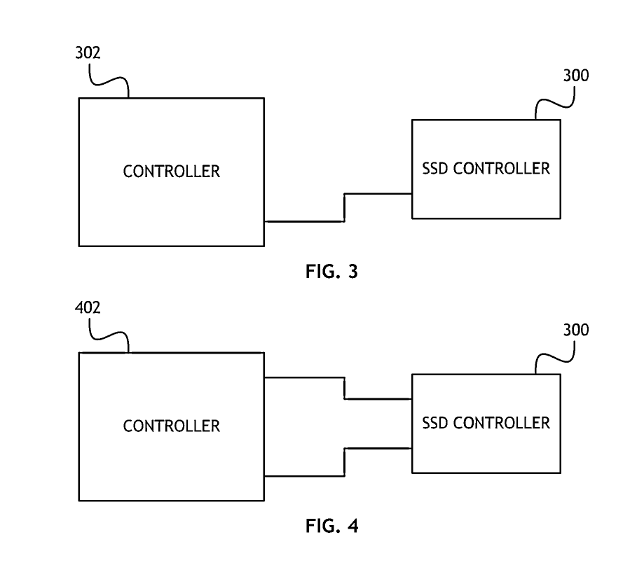

Referring to FIG. 3 and FIG. 4, block diagrams of a system including an SSD controller 300 according to the present invention is shown. In FIG. 3, the system may include a controller 302 connected to the SSD controller 300 through either a first SAS interface or a second SAS interface. In FIG. 4, the controller 402 may be connected to the SSD controller 300 through both the first SAS interface and the second SAS interface.

A controller 302 connected to a SSD controller 300 through a single SAS interface as in FIG. 3 represents a configuration allowing the controller 302 to connect to the maximum number of SSD controllers 300. The SSD controller 300 may have one available SAS interface to connect the SSD controller 300 to another SAS device. A controller 302 connected to a SSD controller 300 through a first SAS interface and a second SAS interface as in FIG. 4 may double the bandwidth available between the controller 302 and the SSD controller 300, and therefore double the bandwidth to the solid state memory elements connected to the SSD controller 300.

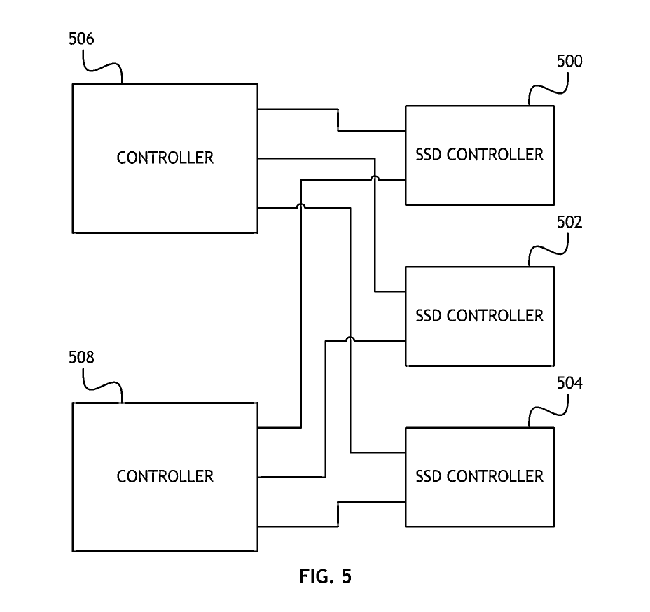

Referring to FIG. 5, a block diagram of a system including two controllers 506, 508 and three SSD controllers 500, 502, 504 is shown. The system may include a first controller 506 and a second controller 508. The first controller 506 may be connected to a first SSD controller 500 through a first SAS interface, to a second SSD controller 502 through a first SAS interface, and to a third SSD controller 504 through a first SAS interface. Likewise, the second controller 508 may be connected to the first SSD controller 500 through a second SAS interface, to the second SSD controller 502 through a second SAS interface, and to the third SSD controller 504 through a second SAS interface. Each of the SSD controllers 500, 502, 054 may be connected to one or more solid state memory elements. In this configuration, the solid state memory elements connected to each of the first SSD controller 500, second SSD controller 502 and third SSD controller 504 may be directly accessible from both the first controller 506 and second controller 508.

One skilled in the art may appreciate that while three SSD controllers 500, 502, 504 are shown, three SSD controllers 500, 502, 504 is not a limitation. The advantages of the present invention in this embodiment may be realized with fewer than three SSD controllers 500, 502, 504, or with more than three SSD controllers 500, 502, 504.

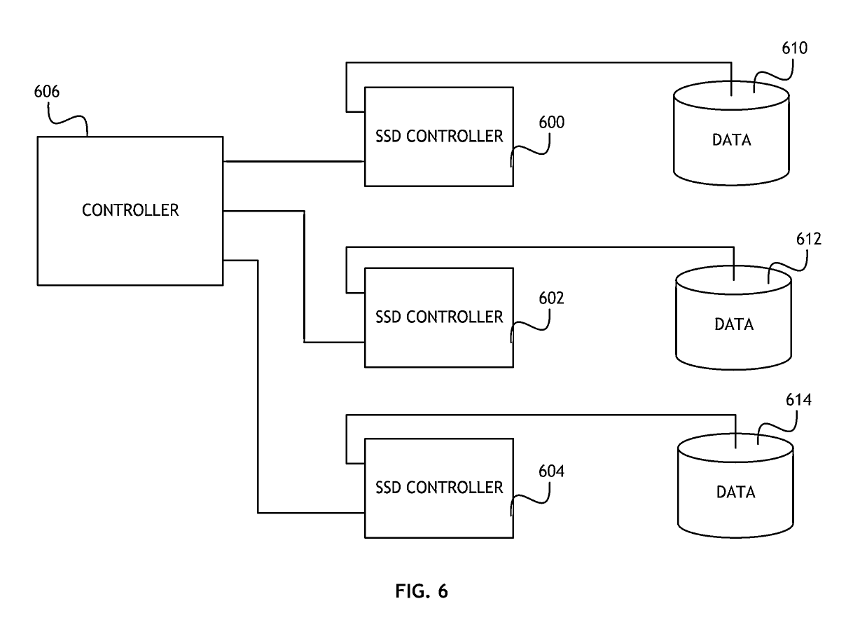

Referring to FIG. 6, a block diagram of a system including a controller 606, three SSD controllers 600, 602, 604 and three hard disk drives (HDDs) 610, 612, 614 is shown. The controller 606 may be connected to a first SAS interface of a first SSD controller 600, a first SAS interface of a second SSD controller 602 and a first SAS interface of a third SSD controller 604. Each of the SSD controllers 600, 602, 604 may be connected to one or more solid state memory elements. The second SAS interface in each of the SSD Controllers 600, 602, 604 allows the controller 606 to connect to the HDDs 610, 612, 614 through the SSD Controllers 600, 602, 604. Without the second SAS interface, the controller 606 would require six separate SAS ports instead of three.

One skilled in the art may appreciate that while three SSD controllers 600, 602, 604 are shown, three SSD controllers 600, 602, 604 is not a limitation. The advantages of the present invention in this embodiment may be realized with fewer than three SSD controllers 600, 602, 604, or with more than three SSD controllers 600, 602,604.

Each of the SSD controllers 600, 602, 604 may be connected a HDD 610, 612, 614. The first SSD controller 600 may be connected to a first HDD 610 through a second SAS interface, the second SSD controller 602 may be connected to a second HDD 612 through a second SAS interface and the third SSD controller 604 may be connected to a third HDD 614 through a second SAS interface.

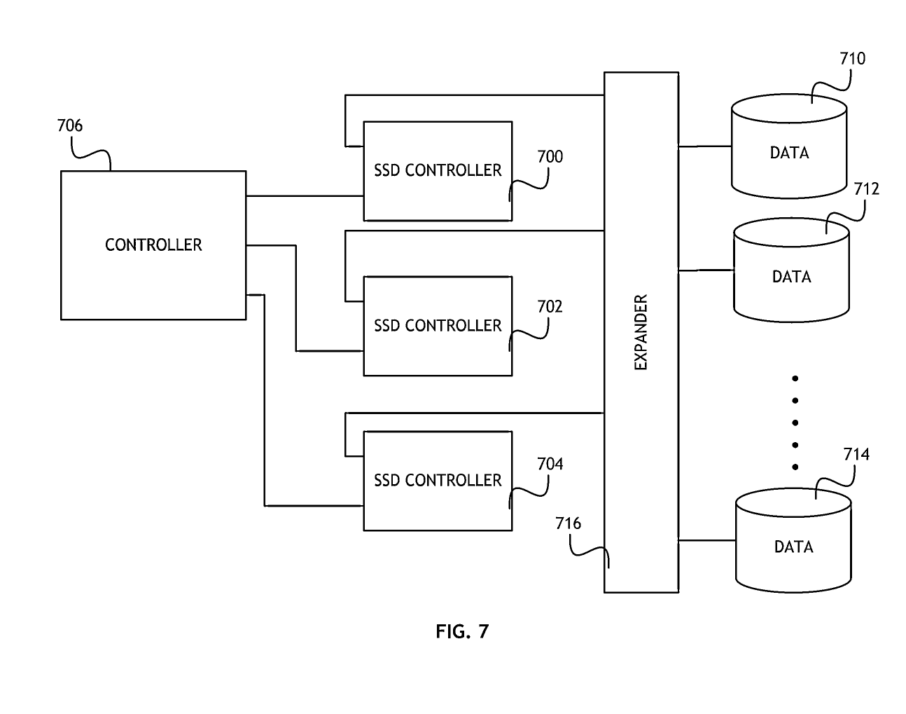

Referring to FIG. 7, a block diagram of a system including a controller 706, three SSD controllers 700, 702, 704, an expander 716 and three HDDs 710, 712, 714 is shown. The controller 706 may be connected to a first SAS interface of a first SSD controller 700, a first SAS interface of a second SSD controller 702 and a first SAS interface of a third SSD controller 704. Each of the SSD controllers 700, 702, 704 may be connected to one or more solid state memory elements. Such an embodiment may be expandable by connecting additional SSD controllers to the controller 706 through a first SAS interface and to the expander 716 through a second SAS interface.

Each of the SSD controllers 700, 702, 704 may be connected the expander 716 through each of their respective second SAS interfaces. Each HDD 710, 712, 714 may also be connected to the expander 716. A person skilled in the art may appreciate that while three HDDs 710, 712, 714 as shown, the present invention is not limited to three HDDs 710, 712, 714.

One skilled in the art may further appreciate that while three SSD controllers 700, 702, 704 are shown, three SSD controllers 700, 702, 704 is not a limitation. The advantages of the present invention in this embodiment may be realized with fewer than three SSD controllers 700, 702, 704, or with more than three SSD controllers 700, 702,704.

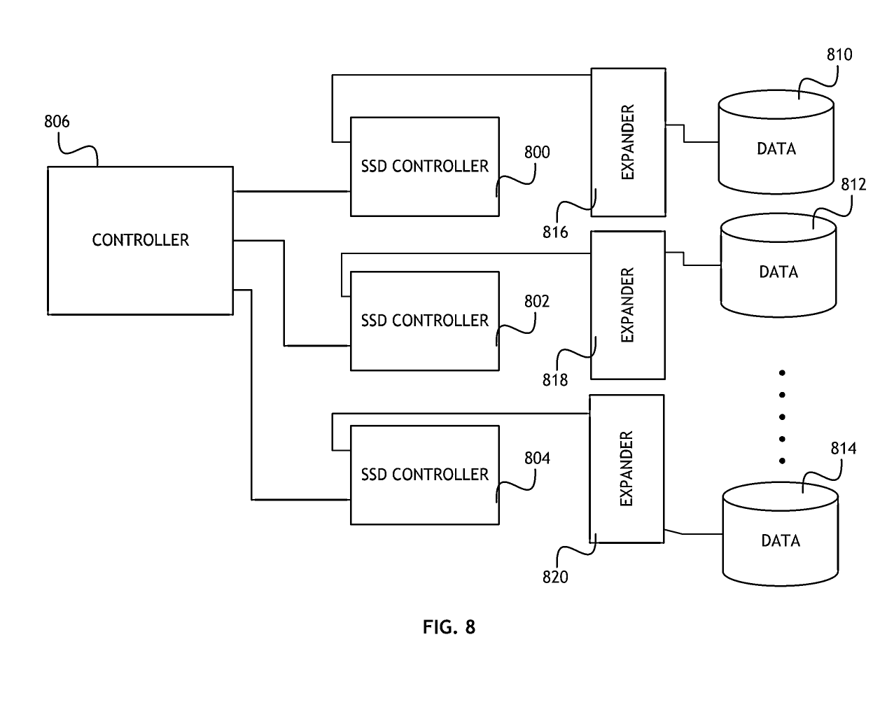

Referring to FIG. 8, a block diagram of a system including a controller 806, three SSD controllers 800, 802, 804, three expanders 816, 818, 820 and three HDDs 810, 812, 814 is shown. The controller 806 may be connected to a first SAS interface of a first SSD controller 800, a first SAS interface of a second SSD controller 802 and a first SAS interface of a third SSD controller 804. Each of the SSD controllers 800, 802, 804 may be connected to one or more solid state memory elements. Such an embodiment may be expandable by connecting additional SSD controllers to the controller 806 through a first SAS interface and to an expander 816, 818, 820 through a second SAS interface.

Each of the SSD controllers 800, 802, 804 may be connected to an expander 816, 818, 820 through each of their respective second SAS interfaces. One or more HDDs 810, 812, 814 may also be connected to one of the expanders 816, 818, 820. A person skilled in the art may appreciate that while three HDDs 810, 812, 814 as shown, the present invention is not limited to three HDDs 810, 812, 814. Furthermore, each expander 816, 818, 820 may be connected to more than one HDD 810, 812, 814.

One skilled in the art may further appreciate that while three SSD controllers 800, 802, 804 are shown, three SSD controllers 800, 802, 804 is not a limitation. The advantages of the present invention in this embodiment may be realized with fewer than three SSD controllers 800, 802, 804, or with more than three SSD controllers 800, 802,804. Furthermore, while each SSD controller 800, 802, 804 is shown connected to a unique expander 816, 818, 820, more than one SSD controller 800, 802, 804 may be connected to any one expander 816, 818, 820.

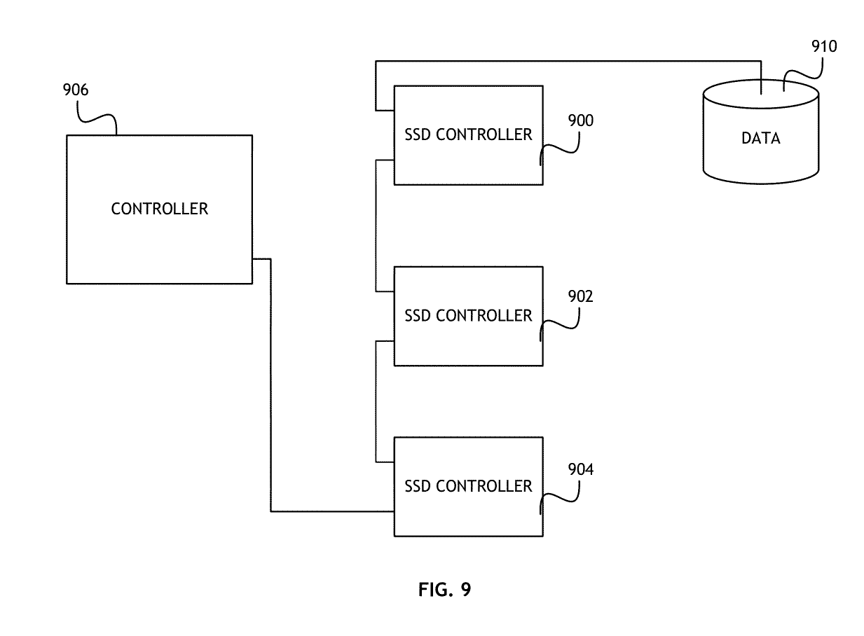

Referring to FIG. 9, a block diagram of a system including a controller 906, three SSD controllers 900, 902, 904 and a HDD 910 is shown. The controller 906 may be connected to a first SAS interface of a first SSD controller 904 while a second SAS interface of a first SSD controller 904 may be connected to a first SAS interface of a second SSD controller 902. A second SAS interface of the second SSD controller 902 may further be connected to a first SAS interface of a third SSD controller 900. Each of the SSD controllers 900, 902, 904 may be connected to one or more solid state memory elements. The second SAS interface of the third SSD Controller 900 may be connected to a HDD 910. This embodiment may allow the controller 906 to connected to flash elements in each of the SSD controllers 900, 902, 904 and to the HDD 910 through a single port.

One skilled in the art may appreciate that while three SSD controllers 900, 902, 904 are shown, three SSD controllers 900, 902, 904 is not a limitation. The advantages of the present invention in this embodiment may be realized with fewer than three SSD controllers 900, 902, 904, or with more than three SSD controllers 900, 902,904.

It may be appreciated by those skilled in the art while the embodiments described herein refer to SAS-based Flash Storage Processors, the “Scaleable Flash Storage Processor” could just as easily be PCIe-based or any other of a number of switchable interconnects.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A solid state storage device controller comprising:
a switch having at least four ports;
a logic circuit connected to the switch; and
a solid state storage device functionality circuit connected to the logic circuit,
wherein:
the solid state storage device functionality circuit is configured to connect to a plurality of solid state storage devices;
one of the ports of the switch is configured as a first interface port; and
one of the ports of the switch is configured as a second interface port.

2. The apparatus of claim 1, wherein the switch is configured as a SAS switch.

3. The apparatus of claim 1, wherein the plurality of solid state storage devices comprise at least one of NAND flash, PCM, ReRAM or MRAM.

4. The apparatus of claim 1, wherein the switch is configured to connect to a first controller through the first interface port.

5. The apparatus of claim 4, wherein the switch is further configured to connect to the first controller through the second interface port.

6. The apparatus of claim 4, wherein the switch is further configured to connect to a first interface port of a second solid state storage device controller through the second interface port.

7. The apparatus of claim 4, wherein the switch is further configured to connect a second controller through the second interface port.

8. The apparatus of claim 4, wherein the switch is further configured to connect to a hard disk drive through the second interface port.

9. The apparatus of claim 4, wherein the switch is further configured to connect to an expander through the second interface port.

10. A solid state storage device controller comprising:
an expander;
a dual port expander multiplexer connected to the expander
a logic circuit to the expander and to the dual port expander multiplexer; and
a solid state storage device functionality circuit connected to the logic circuit,
wherein:
the solid state storage device functionality circuit is configured to connect to a plurality of solid state storage devices;
the expander is configured with a first interface port; and
the dual port expander multiplexer is configured with a second interface port.

11. The apparatus of claim 10, wherein the expander is configured to connect to a first controller through the first interface port.

12. The apparatus of claim 11, wherein the dual port expander multiplexer is further configured to connect the first controller through the second interface port.

13. The apparatus of claim 11, wherein the dual port expander multiplexer is further configured to connect the first controller through the second interface port.

14. The apparatus of claim 11, wherein the dual port expander multiplexer is further configured to connect a second controller through the second interface port.

15. The apparatus of claim 11, wherein the dual port expander multiplexer is further configured to connect to a hard disk drive through the second interface port.

16. The apparatus of claim 11, wherein the dual port expander multiplexer is further configured to connect to an expander through the second interface port.

17. A system comprising:
a first solid state storage device controller comprising:
a first SSD interface comprising a first SSD controller interface port and a first SSD device interface port;
a first SSD logic circuit connected to the first SSD interface element; and
a first SSD functionality circuit configured to connect to a plurality of solid state memory elements,
wherein the first SSD interface is configured to:
receive data traffic through at least one of the first SSD controller interface port and the first SSD device interface port; and
route data traffic to at least one of a device connected to one of the first SSD controller interface port or first SSD device interface port, or the first SSD logic circuit; and
a second solid state storage device controller comprising:
a second SSD interface comprising a second SSD controller interface port and a second SSD device interface port;
a second SSD logic circuit connected to the second SSD interface element; and
a second SSD functionality circuit configured to connect to a plurality of solid state memory elements,
wherein the second SSD interface is configured to:
receive data traffic through at least one of the second SSD controller interface port and the second SSD device interface port; and
route data traffic to at least one of a device connected to one of the second SSD controller interface port or second SSD device interface port, or the second SSD logic circuit,
wherein:
the first solid state storage device controller is configured to connect to a first controller through the first SSD controller interface port;
the second solid state storage device controller is configured to connect to the first controller through the second SSD controller interface port.

18. The system of claim 17, wherein:
the first solid state storage device controller is further configured to connect to a second controller through the first SSD device interface port; and
the second solid state storage device controller is further configured to connect to the second controller through the second SSD device interface port.

19. The system of claim 17, wherein:
the first solid state storage device controller is further configured to connect to a first data storage device through the first SSD device interface port; and
the second solid state storage device controller is further configured to connect to a second data storage device through the second SSD device interface port.

20. The system of claim 17, wherein:
the first solid state storage device controller is further configured to connect to an expander through the first SSD device interface port;
the second solid state storage device controller is further configured to connect to the expander through the second SSD device interface port; and
the expander is configured to connect to a plurality of data storage devices.
